(19) United States
(12) Patent Application Publication
(10) Pub. No.: US 2013/0248692 A1
(43) Pub. Date: Sep. 26, 2013

(54) DETECTING APPARATUS AND METHOD FOR SUBSTRATE

(71) Applicant: Wen-da Cheng, Shenzhen (CN)

(72) Inventor: Wen-da Cheng, Shenzhen (CN)

(73) Assignee: SHENZHEN CHINA STAR OPTOELECTRONICS TECHNOLOGY CO LTD., Shenzhen, Guangdong (CN)

(21) Appl. No.: 13/515,934

(22) PCT Filed: Apr. 26, 2012
(86) PCT No.: PCT/CN12/74754

§ 371 Date: Jun. 14, 2012

(30) Foreign Application Priority Data
Mar. 21, 2012 (CN) 201210075574.6

(51) Int. Cl. G01J 1/42

(52) U.S. Cl. 250/216

(57) ABSTRACT

A detecting apparatus for a substrate includes a light source, a light detecting device and a control device. The light source and the light detecting device are both arranged on the same side of the substrate, a first included angle is formed between the light from the light source and the substrate, and a second included angle is formed between the light received by the light detecting device and the light from the light source. The control device is connected to the light detecting device for controlling the light detecting device to move along a preset path. The light source and the light detecting device of the present disclosure are arranged at appropriate positions where the light detecting device is allowed to only receive light being refracted by glass particles. Therefore, the detecting apparatus is able to detect whether there are glass particles on the substrate in an efficient way.

### BACKGROUND

1. Technical Field

The present disclosure relates to liquid crystal displaying technologies and, particularly, to a detecting apparatus and method for a substrate.

2. Description of Related Art

Liquid crystal display (LCD) is a flat panel display (FPD) that uses the characteristics of liquid crystal to display image. Compared to other types of display, the LCD is thin and it requires lower driving voltage and lower power consumption, which makes it the mainstream product in the consumer goods market.

Liquid crystal panel is the main component of LCD. In the manufacturing process of the liquid crystal panel, a thin film transistor (TFT) array substrate and a color filter substrate are bonded, with a liquid crystal layer sandwiched therebetween. The TFT array substrate and the color filter substrate are both formed via processes including but not limited to deposition processes, exposure processes, and etching processes on a substrate. During the manufacturing process, impurities, especially glass particles, on the substrate will have an adverse effect on the manufacturing of the substrates and or even on the yield rate of the liquid crystal panel, which may result in a waste of the substrates. Therefore, an apparatus and method for detecting whether there are glass particles on the substrate are needed.

### SUMMARY

One object of the present disclosure is to provide a detecting apparatus for a substrate. The detecting apparatus includes a light source, a light detecting device, and a control device. The light source and the light detecting device are both arranged on the same side of the substrate, a first include angle is formed between the light from the light source and the substrate, a second included angle is formed between the light received by the light detecting device and the light from the light source. The control device is connected to the light detecting device for controlling the light detecting device to move along a preset path.

Preferably, the first included angle formed between the light from the light source and the substrate ranges from 0 degree to 90 degrees.

Preferably, the second included angle formed between the light from the light source and the light received by the light detecting device ranges from 70 degrees to 110 degrees.

Preferably, the control device is configured for controlling the light detecting device to move up, down, left, and right related to the substrate.

Preferably, the second included angle formed between the light from the light source and the light received by the light detecting device is equal to 90 degrees.

Preferably, the detecting apparatus further includes another light detecting device, and the two light detecting devices are arranged symmetrically about the light source.

The present disclosure further provides another detecting apparatus for a substrate. The detecting apparatus includes a light source and a light detecting device, the light source and the light detecting device are both arranged on the same side of the substrate, a first include angle is formed between the light from the light source and the substrate, and a second included angle is formed between the light received by the light detecting device and the light from the light source.

Preferably, the first included angle formed between the light from the light source and the substrate ranges from 0 degree to 90 degrees.

Preferably, the second included angle formed between the light from the light source and the light received by the light detecting device ranges from 70 degrees to 110 degrees.

Preferably, the second included angle formed between the light from the light source and the light received by the light detecting device is equal to 90 degrees.

Preferably, the detecting apparatus further includes another light detecting device, and the two light detecting devices are arranged symmetrically about the light source.

The present disclosure also provides a detecting method for a substrate. The detecting method includes the following steps: placing a substrate on a platform; arranging a light source and a light detecting device on the same side of the substrate, a first include angle is formed between the light from the light source and the substrate, and a second included angle is formed between the light received by the light detecting device and the light from the light source; and concluding a result indicating existence of glass particles on the substrate when determining that the light detecting device receives light.

Preferably, the first included angle formed between the light from the light source and the substrate ranges from 0 degree to 90 degrees.

Preferably, the second included angle formed between the light from the light source and the light received by the light detecting device ranges from 70 degrees to 110 degrees.

Preferably, the second included angle is equal to 90 degrees.

Preferably, the second included angle formed between the light from the light source and the light received by the light detecting device ranges from 70 degrees to 110 degrees.

Preferably, the detecting method further includes the following step after the step of turning on the light source and the light detecting device: controlling the light detecting device to move along a preset path.

Preferably, the preset path means the light detecting device moves up, down, left, and right related to the substrate.

The light source and the light detecting device of the present disclosure are arranged at an appropriate position where the light detecting device just receives light being refracted by glass particle other than reflected by other impurities or the substrate. Therefore, the detecting apparatus of the present disclosure is able to detect whether there is glass particle on the substrate in an efficient way.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view of a detecting apparatus for a substrate, according to an embodiment of the present disclosure; the detecting apparatus includes a light source.

FIG. 2 is a schematic view of the light path when light from the light source falls on the glass particle on the substrate.

FIG. 3 is a flow chart of a detecting method for a substrate, according to a first embodiment of the present disclosure.

FIG. 4 is a flow chart of a detecting method for a substrate, according to a second embodiment of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

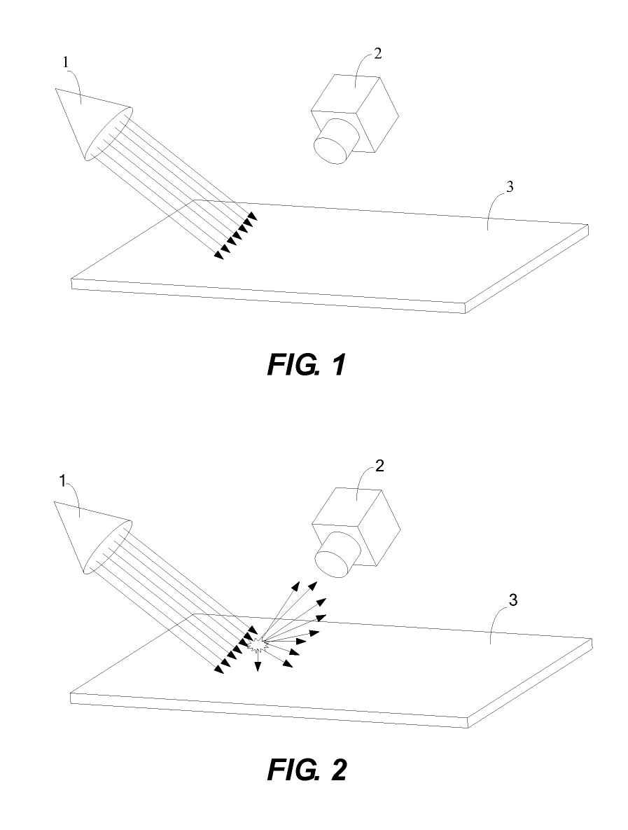

Referring to FIG. 1, a detecting apparatus for a substrate 3, according to an embodiment of the present disclosure, includes a light source 1 and a light detecting device 2. The light source 1 and the light detecting device 2 are both arranged on the same side of the substrate 3. A first included angle is formed between the light from the light source 1 and the substrate 3, and a second included angle is formed between the light received by the light detecting device 2 and the light from the light source 1.

The light emitting from the light source 1 may be reflected or absorbed when falling on impurities except glass particles, but will be refracted when falling on glass particles, as shown in FIG. 2. Therefore, it is an efficient way for the detecting apparatus to detect whether there are glass particles on the substrate by arranging the light detecting device 2 at an appropriate position. At the appropriated position, the light detecting device 2 is allowed to receive only the light being refracted by the glass particles other than the light being reflected by other impurities or the substrate 3.

The first included angle formed between the light emitting from the light source 1 and the substrate 3 ranges from 0 degree to 90 degrees. A third included angle formed between the light received by the light detecting device 2 and the substrate 3 ranges from 0 degree to 90 degrees. The second included angle formed between the light from the light source and the light received by the light detecting device 2 ranges from 70 degrees to 110 degrees, preferably 90 degrees in some embodiments.

The detecting apparatus may further include a control device connected to the light detecting device 2 for controlling the light detecting device 2 to move along a preset path, thus, the glass particles be accurately detected by the light detecting device 2. FIG. 2 schematically shows the light path when light from the light source falls on the glass particle on the substrate. The control device controls the light detecting device 2 to move up, down, left, and right related to the substrate 3. And during the movement of the light detecting device 2, the second included angle formed between the light from the light source and the light received by the light detecting device 2 should be kept in a range from 70 degrees to 110 degrees. It is noted that the number of the detecting apparatus is not limited to this embodiment. In alternative embodiments, the detecting apparatus may include more than one light detecting device 2, like two light detecting devices 2 arranged symmetrically about the light source 1.

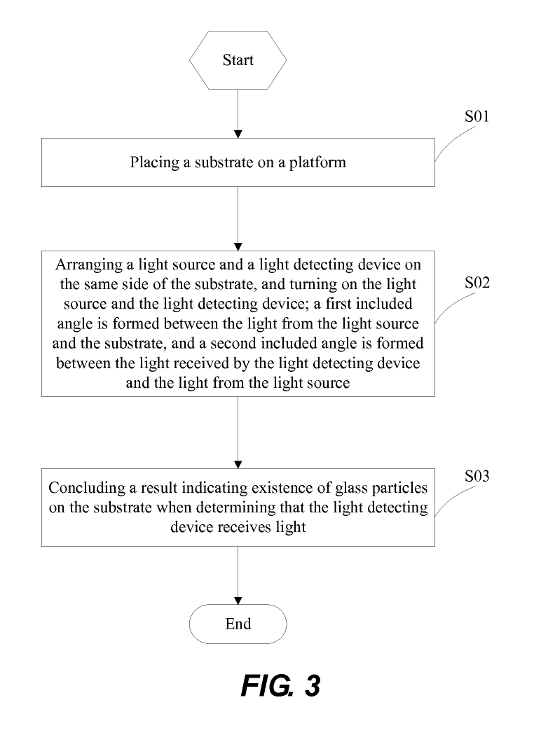

Referring to FIG. 3, the present disclosure further provides a detecting method of a substrate. The detecting method includes the following steps:

Step S01: placing the substrate 3 on a platform;

Step S02: arranging both the light source 1 and the light detecting device 2 on the same side of the substrate 3, and turning on the light source 1 and the light detecting device 2. The light from the light source 1 is inclined related to the substrate 3, that is, a first included angle is formed between the light from the light source 1 and the substrate 3. A second included angle is formed between the light received by the light detecting device 2 and the light from the light source 1. Specifically, the first included angle formed between the light from the light source 1 and the substrate 3 ranges from 0 degree to 90 degrees. The second included angle formed between the light from the light source and the light received by the light detecting device 2 ranges from 70 degrees to 110 degrees, preferably 90 degrees in some embodiments. A third included angle formed between the light received by the light detecting device 2 and the substrate 3 ranges from 0 degree to 90 degrees,

Step S03: concluding a result indicating existence of glass particles on the substrate when determining that the light detecting device receives the light.

The above mentioned detecting method uses the physical characteristic of light, that is, the light from the light source 1 will be refracted when falling on glass particles and may be reflected or absorbed when falling on impurities except glass particles, as shown in FIG. 2. Therefore, it is an efficient way for the detecting apparatus to detect whether there are glass particles on the substrate by arranging the light detecting device 2 at an appropriate position where the light detecting device 3 is allowed to receive only the light refracted by the glass particles other than reflected by other impurities or the substrate 3.

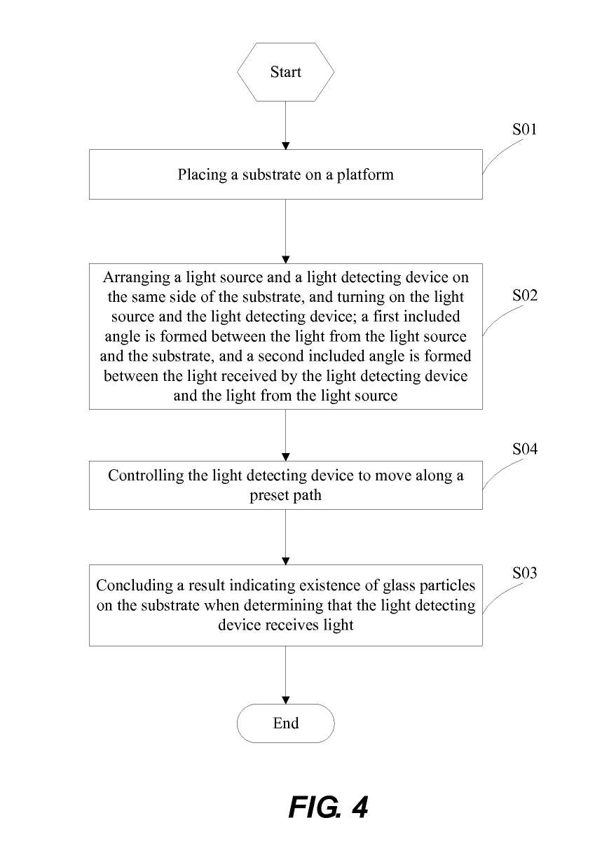

Referring to FIG. 4, a detecting method for the substrate 3, according to a second embodiment of the present disclosure is shown. The difference between the detecting method of this embodiment and the detecting method of the first embodiment lies in that, the detecting method in this embodiment further includes a step S04 after the step of S02, that is, step S04: controlling the light detecting device 2 to move along a preset path.

To make glass particles be accurately detected by the light detecting device 2, a control device (not shown) can be employed to control the light detecting device 2 to move along the preset path. As shown in FIG. 2, the light detecting device 2 can be controlled to move up, down, left, and right related to the substrate 3. And during the movement of the light detecting device 2, the second included angle formed between the light from the light source and the light received by the light detecting device 2 should be kept in a range from 70 degrees to 110 degrees. It is noted that the number of the light detecting device 2 is not limited to this embodiment. In alternative embodiments, more than one light detecting device 2, like two light detecting devices 2, can be arranged symmetrically about the light source 1 for detecting the substrate 3.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A detecting apparatus for a substrate, comprising:
a light source;
a light detecting device, wherein the light source and the light detecting device are both arranged on the same side of the substrate, a first include angle is formed between light from the light source and the substrate, a second included angle is formed between light received by the light detecting device and the light from the light source; and
a control device connected to the light detecting device for controlling the light detecting device to move along a preset path.

2. The detecting apparatus as claimed in claim 1, wherein the first included angle formed between the light from the light source and the substrate ranges from 0 degree to 90 degrees.

3. The detecting apparatus as claimed in claim 2, wherein the second included angle formed between the light from the light source and the light received by the light detecting device ranges from 70 degrees to 110 degrees.

4. The detecting apparatus as claimed in claim 3, wherein the control device is configured for controlling the light detecting device to move up, down, left, and right related to the substrate.

5. The detecting apparatus as claimed in claim 4, wherein the second included angle formed between the light from the light source and the light received by the light detecting device is equal to 90 degrees.

6. The detecting apparatus as claimed in claim 1 further comprising another light detecting device, wherein the two light detecting devices are arranged symmetrically about the light source.

7. A detecting apparatus for a substrate, comprising a light source and a light detecting device, wherein the light source and the light detecting device are both arranged on the same side of the substrate, a first include angle is formed between light from the light source and the substrate, and a second included angle is formed between light received by the light detecting device and the light from the light source.

8. The detecting apparatus as claimed in claim 7, wherein the first included angle formed between the light emitting from the light source and the substrate ranges from 0 degree to 90 degrees.

9. The detecting apparatus as claimed in claim 8, wherein the second included angle formed between the light from the light source and the light received by the light detecting device ranges from 70 degrees to 110 degrees.

10. The detecting apparatus as claimed in claim 9, wherein the second included angle formed between the light from the light source and the light received by the light detecting device is equal to 90 degrees.

11. The detecting apparatus as claimed in claim 7 further comprising another light detecting device, wherein the two light detecting devices are arranged symmetrically about the light source.

12. A detecting method for a substrate, comprising:
placing a substrate on a platform;
arranging a light source and a light detecting device on the same side of the substrate, a first include angle is formed between light from the light source and the substrate, and a second included angle is formed between light received by the light detecting device and the light from the light source; and
concluding a result indicating existence of glass particles on the substrate when determining that the light detecting device receives light.

13. The detecting method as claimed in claim 12, wherein the first included angle formed between the light emitting from the light source and the substrate ranges from 0 degree to 90 degrees.

14. The detecting method as claimed in claim 13, wherein the second included angle formed between the light emitting from the light source and the light received by the light detecting device ranges from 70 degrees to 110 degrees.

15. The detecting method as claimed in claim 14, wherein the second included angle is equal to 90 degrees.

16. The detecting method as claimed in claim 12, wherein the second included angle formed between the light from the light source and the light received by the light detecting device ranges from 70 degrees to 110 degrees.

17. The detecting method as claimed in claim 12 further comprising the following step after the step of turning on the light source and the light detecting device:
controlling the light detecting device to move along a preset path.

18. The detecting method as claimed in claim 17, wherein the preset path means the light detecting device moves up, down, left, and right related to the substrate.
